(19) United States
(12) Patent Application Publication
(10) Pub. No.: US 2018/0040229 A1
(43) Pub. Date: Feb. 8, 2018

(54) PORTABLE PERSONAL EMERGENCY ALERT SYSTEM AND ASSOCIATED METHODS

(71) Applicant: Parthiban Munusamy, Freemont, CA (US)

(72) Inventor: Parthiban Munusamy, Freemont, CA (US)

(21) Appl. No.: 15/624,560

(22) Filed: Jun. 15, 2017

Related U.S. Application Data
(63) Continuation of application No. PCT/US2016/031945, filed on May 11, 2016.

(51) Int. Cl. G08B 25/01; G08B 21/02

(52) U.S. Cl. CPC G08B 25/016; G08B 21/0277; G08B 21/0283

(57) ABSTRACT

A portable personal emergency alert system is described that includes a low-energy communication protocol transmitter activatable by a user and configured to periodically transmit a data packet including a Universally Unique Identifier (UUID) for a predetermined time. A wireless transceiver is operable to receive the data packet transmission and subsequently transmit the data packet via cellular transmission. A centralized computer server in a data center is configured to receive the cellular transmission, process the data packet to determine a desired recipient, and transmit an alert to the desired recipient.

### PRIORITY CLAIM

This application is a continuation of International Application PCT/US16/31945, with an international filing date of May 11, 2016, which claims benefit of U.S. Provisional Patent Application No. 62/159,832, filed May 11, 2015, both of which are herein incorporated by reference in their entirety for all purposes.

### BACKGROUND OF THE INVENTION

### Field of the Invention

The present invention relates generally to portable personal emergency beacons and more particularly to personal emergency beacons that call out for help in the electronic background using wireless carrier signals, and which gather and periodically transmit situational data such as GPS location and AV recordings of the location of the beacon.

### Related Art

Portable personal emergency alert devices exist that use wireless communication technology to alert emergency response personnel to a user's condition when the user activates the device. Often, these personal alert devices are a pendant with an activation button that is worn by the user. When the portable alert device is activated a phone call is initiated to a dispatch operator who directs the call to appropriate emergency response personnel. These portable alert devices are often small, battery powered, wireless transceivers that allow a user to both talk and listen to a dispatch operator.

The range of such portable alert devices varies depending on the type of wireless communication employed by the portable alert device. For example, an alert device using an RF link to a local telephone line may have a range of several hundred feet from a telephonic base station, whereas an alert device coupled to a satellite network may have a virtually unlimited range.

Unfortunately, such portable alert devices have several limitations and problems. First, the activation and use of the alert device depends on if the alert device is within range of the linked or coupled receiver. If no connection is established, the alert device will cease transmission and require re-activation by the user in hopes of establishing a connection.

Second, such alert devices have a limited battery life, and powering a speaker, microphone, and transceiver can quickly drain the battery so that communication with a receiver may not be long enough to provide critical information to the receiver before the battery fails. For example, in the case of an ongoing crime a user may be involved for several hours or even days before the situation is resolved. During this time, continuous use of the alert device can drain the battery rendering the alert device useless once the battery is dead.

Additionally, portable alert devices generally rely on connection with a remote dispatch service that is often many miles away. The dispatch service must then contact and pass on relevant information to the appropriate response personnel, who also may be many miles away. Establishing multiple connections and potentially long travel distances can delay response from first responders. Such a delay in response time has proven catastrophic to users of portable personal alert devices.

### SUMMARY OF THE INVENTION

The inventor of the present invention has recognized that it would be advantageous to develop a portable personal alert system with alert devices that transmit information regardless of whether a wireless receiver is connected with the alert device. Furthermore, the inventor has recognized that it would be advantageous to develop a portable personal alert system with alert devices that conserve power usage through low power periodic transmissions. Additionally, the inventor has recognized that it would be advantageous to develop a portable personal alert system that directly alerts potential first responders in closest proximity to the personal alert device to minimize response time.

The invention provides for a portable personal emergency alert system that includes a low-energy communication protocol transmitter activatable by a user and configured to periodically transmit a data packet including a Universally Unique Identifier (UUID) for a predetermined time. A wireless transceiver can be operable to receive the data packet transmission and subsequently transmit the data packet via cellular transmission. A centralized computer server in a data center can be configured to receive the cellular transmission, process the data packet to determine a desired recipient, and transmit an alert to a desired recipient. The present invention also provides for a method for alerting a desired recipient of an emergency situation. The method can include distributing a wireless low energy communication protocol transmitter with a unique serial number to a user. A good Samaritan responder app can be distributed to wireless transceivers of participating good Samaritan responders. The wireless transceivers of the participating good Samaritan responders can be connected to the tracking program of the centralized computer server upon electronic registration of the app in order to establish a network between the wireless transceivers of the participating good Samaritan responders and the centralized computer server. The network can be monitored via software instructions on the centralized computer server for transmissions from the wireless transceivers indicating receipt of a transmission from the low energy communication protocol transmitter. The transmission from the low energy transmitter and the wireless transceiver can be analyzed by the centralized computer server to determine the identity of the user of the low energy transmitter, the location of the emergency transmitter when the transmission was made, the responder contact information for the user, the user of the cellular transceiver, and the location of the cellular transceiver. The responders can be notified via communication transmission from the centralized computer server.

In another aspect of the present invention, the method can also include identifying and notifying good Samaritan responders in a relatively nearby proximity to the low energy communication protocol transmitter so that the good Samaritan responders can assist the user of the transmitter more quickly than official responders.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 is a schematic view of an emergency alert system in accordance with an embodiment of the present invention;

FIG. 2 is a schematic view of a low energy communication protocol transmitter for use in the emergency alert system of FIG. 1;

FIG. 3 is a flow chart of a method for alerting a desired recipient of an emergency situation in accordance with another embodiment of the present invention; and

FIG. 4 is a flow chart of a method for alerting another desired recipient of the emergency situation in accordance with the embodiment of FIG. 3.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

The embodiments of the present invention described herein generally provide for an emergency alert system that includes a low energy communication protocol transmitter that can be activated by a user in the event of an emergency situation. The low energy communication protocol transmitter can include a Bluetooth Low Energy (BTLE) beacon that can transmit data packets at a low energy level periodically over great lengths of time. The data packets can include a Universally Unique Identifier (UUID) as well as personal information about the user and the user's location and environment at the time the user activated the transmitter. Although transmitted at a low energy communication protocol the transmissions can be picked up by nearby wireless transceivers such as cellular telephones and forwarded via the cellular signal to a centralized computer server at a data processing center for analysis. In one aspect, the cellular transceiver can be the users own cellular telephone. In another aspect, the cellular transceiver can include nearby cellular telephones belonging to third parties who have joined the emergency alert system contemplated in this embodiment. Such third parties can act merely as cellular transceivers in the system or they may also act as good Samaritan first responders that can directly respond and intervene with the user who activated the low energy communication protocol transmitter. Once the data packet reaches the data processing center, the centralized computer server can process the data packet to determine the most appropriate response to the user's emergency circumstances. Such a response can include alerting a predetermined first responder contact list based on the user's input, alerting Emergency Medical Services (EMS), and finding and alerting all registered good Samaritan first responders in the immediate vicinity of the user. The centralized computer server can also forward relevant personal medical information, location and environmental information received from the low energy transmitter data packets to all relevant first responders.

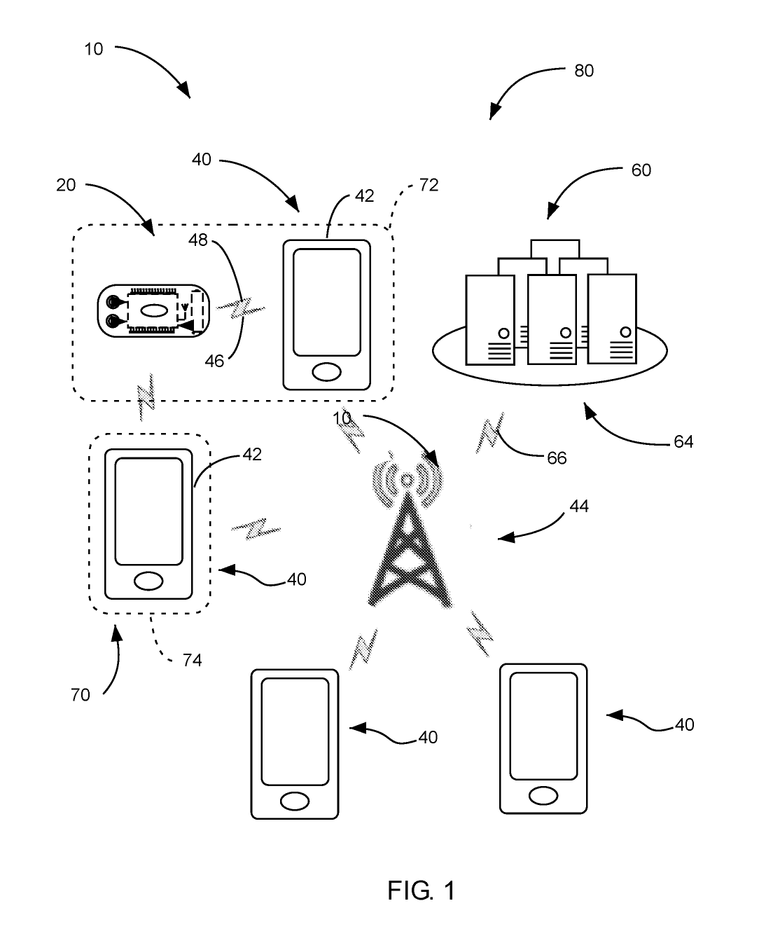

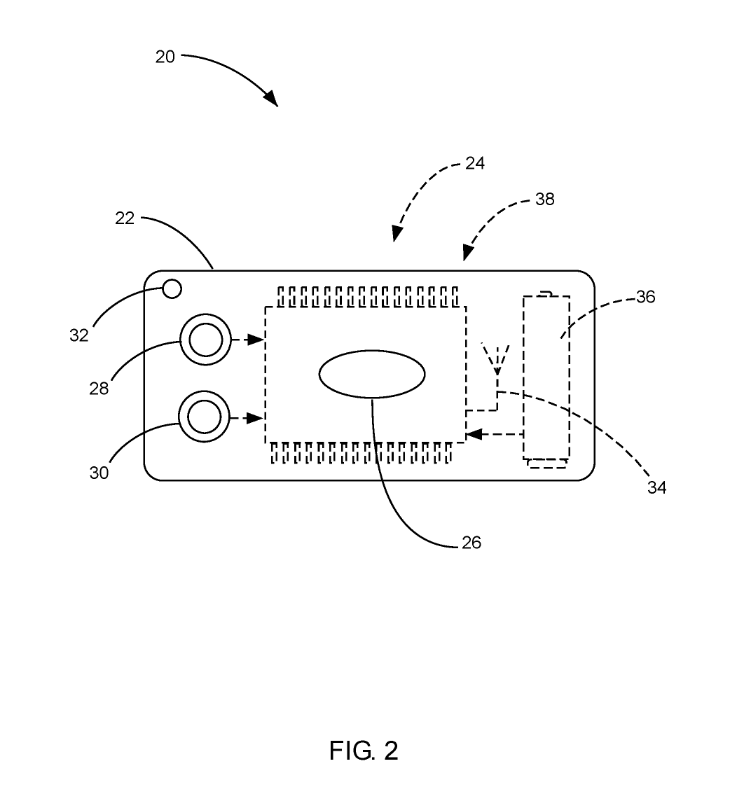

As illustrated in FIGS. 1-2, a portable personal emergency alert system, indicated generally at 10, is shown for use in communicating an emergency situation to emergency responders. The emergency alert system 10 can include a low energy communication protocol transmitter, indicated generally at 20, a wireless transceiver, indicated generally at 40, and a centralized computer server, indicated generally at 60.

As best seen in FIG. 2, the low-energy communication protocol transmitter 20 can include a pendant style housing 22 that can house a Bluetooth Low Energy (BTLE) transmitter or beacon, indicated generally at 24. The BTLE transmitter 24 can be activated by one or more buttons 26 on the pendant. It will be appreciated that while the housing 22 is shown as a pendant in FIG. 2, any suitable shape might also be employed, and generally the housing 22 can be small enough to be incorporated into wearable devices such as the pendant as shown in FIG. 2, or other wearable devices such as a watch, bracelet, necklace, key fob, and the like.

Additionally, the BTLE transmitter 24 can include a microphone 28 and camera 30 so that the BTLE transmitter 24 can record audio visual data of the surrounding environment. The audio-visual data can be transmitted by the BTLE transmitter 24 as part of the data packet. The BTLE transmitter 24 can also have a visual indicator 32 such as an LED light that can inform the user that the BTLE transmitter 24 is functioning properly and broadcasting the data packet.

The buttons 26 of the housing 22 can be electronically coupled to a solid state preprogrammed processor transistor chip, indicated generally at 38, that can be disposed within the housing 22. The chip can include the BTLE transmitter 24, GPS locator, and a CPU for processing data. The BTLE transmitter 24 can include a unique serial number that can be registered with the Emergency Alert System 10. The BTLE transmitter 24 can be coupled to an antennae 34 and a power supply 36, such as a battery, so as to be able to generate a Radio Frequency (RF) signal with a frequency and format determined by Bluetooth protocol as known in the art.

The BTLE transmitter 24 can be activated by a user (not shown) depressing one or more of the buttons 26 on the pendant housing 22. When the BTLE transmitter 24 is activated the transmitter low energy communication protocol transmitter 20 can periodically transmit a data packet including a Universally Unique Identifier (UUID) for a predetermined burst of time. After transmitting the data packet, the BTLE transmitter 24 can cease broadcast for a predetermined time and then rebroadcast the packet again. In this way, the BTLE transmitter 24 can periodically broadcast, or advertise, the data packet at intervals for as long as the BTLE transmitter is activated or for the life of the power supply 36.

The BTLE transmitter 24 can be preprogrammed with one or more Universally Unique identifiers that can be transmitted with the data packet. For example, in one embodiment the BTLE transmitter 24 can be preprogrammed with a 16-byte UUID, a 16-byte Unique Major Number, and a 16-byte Unique Minor Number as defined by Apple™ iBeacon™ protocol which can be broadcast over the protocol's RF signals.

In this embodiment, when a button 26 is pressed on the low energy communication protocol transmitter 20 one of the preprogrammed 16-byte UUID, the 16-byte Unique Major Number, and the 16-byte Unique Minor Number as defined by Apple™ iBeacon™ protocol can be broadcast over the protocol's RF signals. Between each activation of the buttons 26 on the transmitter 20, any of the 16-byte Universal Unique Identifier (UUID), the 16-bit unique major number and the 16-bit unique minor number might be changed to a different number to avoid unwanted identification of the sequence specific to the transmission device.

Returning to FIG. 1, the wireless transceiver 40 can be operable to receive the data packet transmission 46 from the low energy communication protocol transmitter 20, and subsequently transmit the data packet via cellular transmission. Although not shown in the figures, it will be appreciated that the wireless transceiver 40 can include a data processor, a Bluetooth receiving and transmitting module, a wireless receiving and transmitting module, a Bluetooth RF receiving antenna, a wireless RF receiving and transmitting antenna, and a location module such as GPS, as known in the art. For example, in one aspect the wireless transceiver 40 can be a mobile cellular phone 42 as shown in FIG. 1. The cellular phone 42 can receive the data packet 46 in the form of Bluetooth Low Energy RF signals 48 from the low energy communication protocol transmitter 20, transform data in the Bluetooth signal into data in a cellular signal, and transmit the cellular signal via a cellular transmission tower, indicated generally at 44.

It will be appreciated that other wireless transceivers such as mobile satellite phones, mobile tablet computers equipped with cellular signal service, smart phones, smart tablets, laptop computers, desktop computers, and the like as known in the art, can also be used. Generally, any device with Bluetooth RF signal capabilities and cellular or satellite connectivity could be used as the wireless transceiver 40 of the present invention.

The wireless transceiver 40 can also include a software application (app) that can be programmed to search and listen for low energy communication protocol transmissions 48 in the background of the operation of the wireless transceiver 40. The app can be programmed to wake up the wireless transceiver 40 and alert the user of the wireless transceiver when a UUID associated with a registered low energy communication protocol transmitter 20 is detected in a transmitted data packet 46. The app can also be programmed to receive the transmitted data packet 46 so long as the UUID is a recognized preprogrammed UUID irrespective of the 16-byte Major and Minor IDs of the data packet.

The centralized computer server 60 can be associated with a data processing center 62 indicated generally at 64. The centralized computer server 60 can include programming to receive transmissions 66 from the wireless transceiver 40 via the cell tower 44. The central computer server 60 can then receive and process the data packet from the low energy communication protocol transmitter 20 to determine a desired recipient of the data in the data packet and then transmit an alert to the desired recipient. In the event of an emergency situation at the location of the low energy communication protocol transmitter 20, the desired recipients can be trained first responders such as Emergency Medical Services (EMS) personnel, first responders from nearby cell phone users represented generally at 70 who have activated the app on their cell phones 42 in order to be registered good Samaritan first responders, or first responders from a predetermined list of emergency contacts preprogrammed into the centralized computer server 60.

The wireless transceiver 40 can be in constant communication with the centralized computer server 60 via the software app residing and operating in the background of the wireless transceiver. The centralized computer server 60 can have information about each of the low energy communication protocol transmitters 20 registered with the emergency alert system 10 including personal information, such as emergency contact information, with respect to the users of the low energy communication protocol transmitters.

Additionally, because the centralized computer server 60 is in constant communication with all of the various wireless transceivers that are using the app, the centralized computer server has continual information as to the current location of all known and registered good Samaritan first responders and any mobile EMS units. In this way, the centralized computer server 60 forms a communication network, indicated generally at 80, with the low energy communication protocol transmitters 20 and the wireless transceivers 40.

In use, when a wireless transceiver 40 such as a cell phone of a registered app user enters the vicinity of an activated and currently transmitting low energy communication protocol transmitter 20, such as a BTLE beacon 24, the cell phone will pick up the beacon broadcast and transmit the UUID of the BTLE beacon to the centralized computer server 60. The centralized computer server 60 will verify that the UUID of the beacon is one of the preprogrammed UUIDs in the emergency system 10 and will send an authorization to the cell phone to record and transmit the full content of the data packet from the low energy communication protocol transmitter 20. The full content of the data packet can include the 16-byte Unique Universal Identifier, 16-bit Major, 16-bit Minor and a derived RSSI value to estimate the distance of the BTLE transmitter from the wireless receiver, current location co-ordinates, time of receipt, and local cell phone device specific identifiers including the owner of the cell phone.

The data packet can also include information of the user's medical conditions and allergies and can have updated location information from every time the periodic data packet is sent so as to enable first responders to track the alert device over time. The centralized computer server 60 can transmit information from the data packet to all emergency contacts of the transmitter user and to all good Samaritan responders in the area of the user and the user in turn can be informed via feedback to the transmitter that help has been summoned.

When the full content of the data packet has been transmitted from the wireless transceiver 40 and received by the centralized computer server 60, the server will conduct a network search for all active Wi-Fi MAC addresses of nearby devices and any actively broadcasting nearby Bluetooth devices and their Generic Attribute (GATT) Profiles. All the search results will be sent to the centralized computer server 60 where the information will be stored for use by law enforcement who may need to conduct crime scene forensics to identify all the nearby devices and the owners.

In one aspect, the low energy communication protocol transmitter 20 and the wireless transceiver 40 can be operable by a single user, represented by dashed line at 72. If the wireless transceiver 40 is a cell phone 42 that belongs to the user of the BTLE transmitter 20, the cell phone app can wait for a predetermined time frame for the user to abort the beacon transmission in case the transmission was an accidental activation of the beacon. If the transmission is not aborted then the centralized computer server 60 can start informing all the emergency contacts and other desired recipients, as predesignated by the user, of the beacon transmission.

In another aspect, the low energy communication protocol transmitter 20 can be activated by a first user 72 and the wireless transceiver 40 can be operable by a second user, represented by dashed line at 74, who is a potential first responder. If the wireless transceiver 40 is a cell phone 42 that belongs to a second user 74, and if the cell phone is in relatively close proximity to the BTLE transmitter 24, based on the Received Signal Strength Indicator (RSSI) value, then the cell phone app can direct the cell phone 42 to begin recording audio visual recordings at a designated interval such as 10 second intervals. The cell phone app can then upload the recordings to the centralized computer server 60. The recordings can be used by law enforcement and EMS responders to determine the nature of the emergency, and as evidence in future criminal prosecutions if necessary.

In yet another aspect, the low energy communication protocol transmitter 20 can be activated by a first user and a plurality of wireless transceivers 40 can receive the transmission. In this case, each wireless transceiver 40 can be operable by a different user and each user can be a potential first responder.

The centralized computer server 60 can send out notifications to all the registered good Samaritan wireless transceivers 40 within a predetermined radius of the currently activated BTLE transmitter 24. The good Samaritan responders can then assist the user of the BTLE transmitter 24 and may in fact be the fastest first responders since they may likely be significantly closer to the beacon and have faster response times than other EMS, police, or fire department responders.

It is a particular advantage of the present invention that the user of the BTLE transmitter 24 need not have a wireless transceiver 40 such as a cell phone for the Beacon to be effective at sending and emergency alert. In scenarios where a crime such as kidnapping occurs, the perpetrators of the crime are likely to get rid of any type of cell phone of the victim in the course of the crime. However, the small pendant BTLE transmitter 24 may go unnoticed and may be less suspect to the kidnappers who likely would not be able to receive the low energy communication protocol transmission since it is unlikely the kidnappers would have the registered app on their cell phones. In this case, the BTLE transmitter 24 will continue to broadcast and can be picked up by any registered cell phone of a nearby participating user.

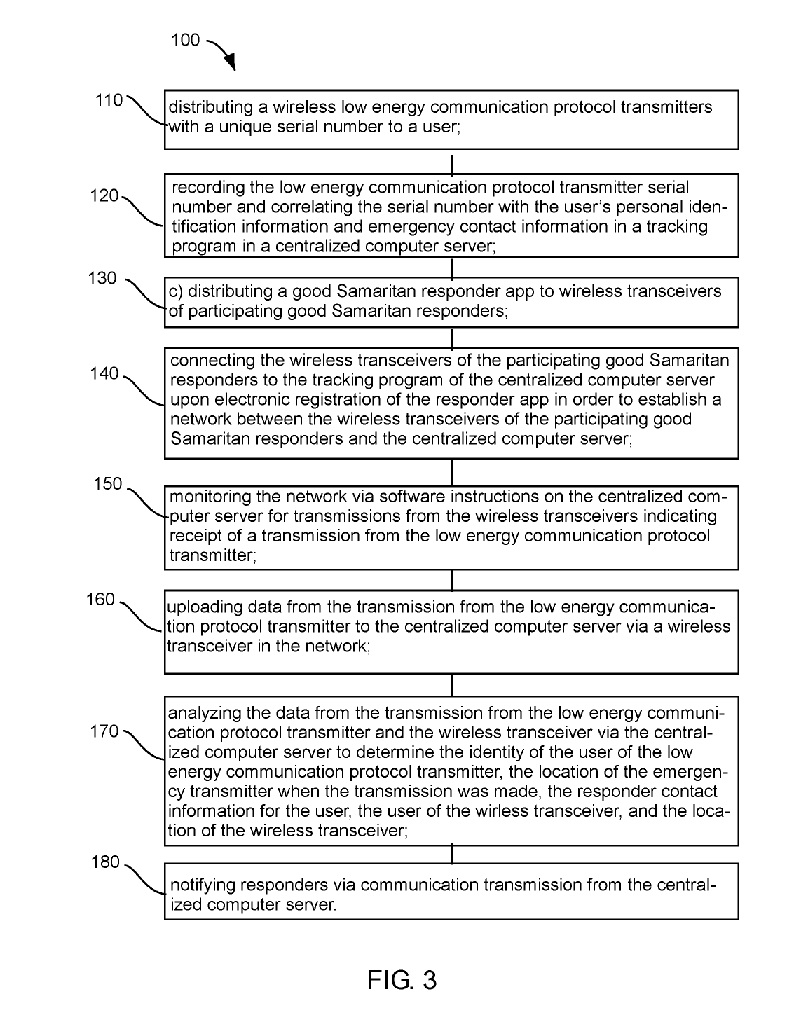

As illustrated in FIG. 3, the present invention also provides for a method for alerting a desired recipient of an emergency situation, indicated generally at 100. The method 100 can include distributing a wireless low energy communication protocol transmitter with a unique serial number to a user, as shown at 110. The transmitter serial number can be recorded and correlated with the user's personal identification information and emergency contact information in a tracking program in a centralized computer server, as shown at 120. A good Samaritan responder app can be distributed to cellular transceivers of participating good Samaritan responders, as shown at 130. The cellular transceivers of the participating good Samaritan responders can be wirelessly connected to the tracking program of the centralized computer server upon electronic registration of the app in order to establish a network between the cellular transceivers of the participating good Samaritan responders and the centralized computer server, as shown at 140. The network can be monitored via software instructions on the centralized computer server for transmissions from the cellular transceivers indicating receipt of a transmission from the low energy communication protocol transmitter, as shown at 150. The transmission can be uploaded from the low energy transmitter to the centralized computer server via a wireless transceiver, such as a cellular phone, in the network, as shown at 160. The communication transmission from the low energy transmitter and the cellular transceiver can be analyzed by the centralized computer server to determine the user of the low energy transmitter, the location of the emergency transmitter when the transmission was made, the responder contact information for the user, the user of the cellular transceiver, and the location of the cellular transceiver, as shown at 170. The responders can be notified via communication transmission from the centralized computer server, as shown at 180.

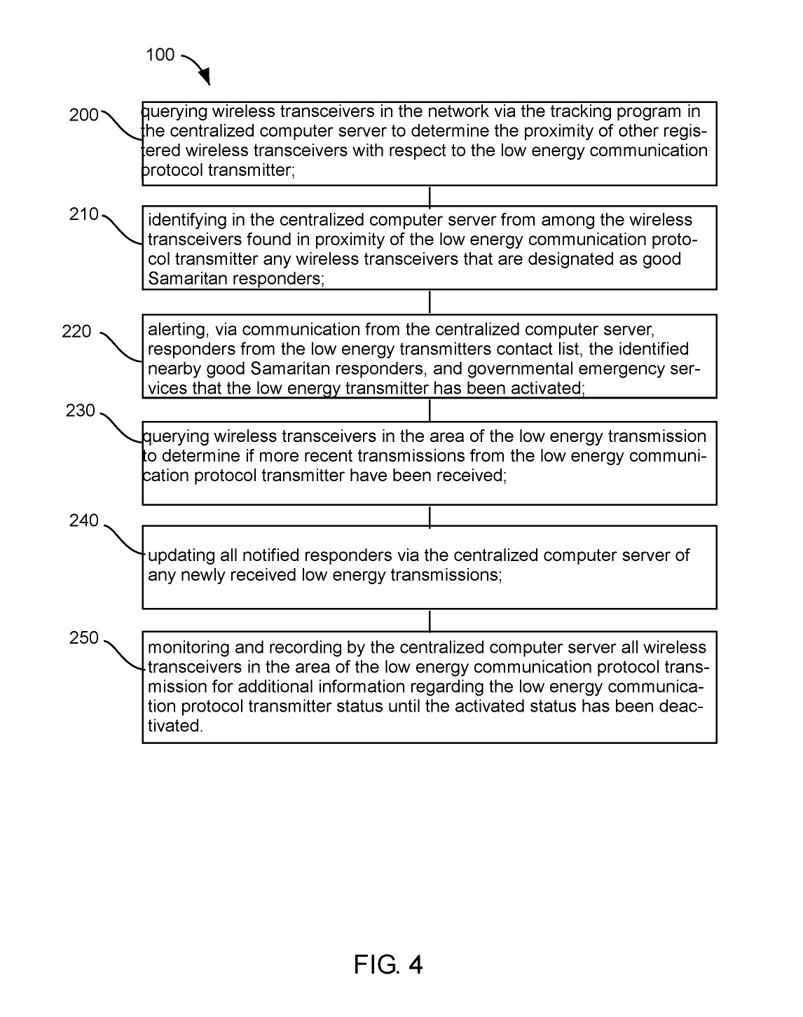

As shown in FIG. 4, the method 100 also includes querying wireless transceivers, such as cell phones, in the network via the tracking program in the centralized computer server to determine the proximity of other registered wireless transceivers with respect to the low energy communication protocol transmitter, as shown at 200. Any cellular transceivers that are designated as good Samaritan responders in the centralized computer server can be identified from among the cellular transceivers found in proximity of the low energy communication protocol transmitter, as shown at 210. Responders from the low energy transmitters contact list, the identified nearby good Samaritan responders, and governmental emergency services can be alerted, via communication from the centralized computer server, that the low energy transmitter has been activated, as shown at 220. Cellular transceivers in the area of the low energy transmission can be queried to determine if more recent transmissions from the low energy communication protocol transmitter have been received, as shown at 230. All notified responders can be updated via the centralized computer server of any newly received low energy transmissions, as shown at 240. All cellular transceivers in the area of the low energy transmission can be monitored and recorded by the centralized computer server for additional information regarding the low energy transmitter status until the activation status has been deactivated, as shown at 250.

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred embodiment(s) of the invention, it will be apparent to those of ordinary skill in the art that numerous modifications can be made without departing from the principles and concepts of the invention as set forth herein.

What is claimed is:

1. A portable personal emergency alert system, comprising:
a) a low-energy communication protocol transmitter activatable by a user and configured to periodically transmit a data packet including a Universally Unique Identifier (UUID) for a predetermined time;
b) a wireless transceiver operable to receive the data packet transmission and subsequently transmit the data packet via wireless transmission; and
c) a centralized computer server in a data center configured to receive the cellular transmission, process the data packet to determine a desired recipient and transmit an alert to a desired recipient.

2. The system of claim 1, wherein the low-energy communication protocol transmitter includes a Bluetooth Low Energy (BTLE) beacon.

3. The system of claim 1, wherein the wireless transceiver includes a cellular transceiver.

4. The system of claim 1, wherein the wireless transceiver includes a software application that is programmed to listen for the low energy communication protocol transmission in the background of the operation of the wireless transceiver and to sound an alert when an associated UUID is detected.

5. The system of claim 1, wherein the low energy communication protocol transmitter and the wireless transceiver are operable by a single user.

6. The system of claim 1, wherein the low energy communication protocol transmitter is activated by a first user and the wireless transceiver is operable by a second user who is a potential first responder.

7. The system of claim 1, further comprising a plurality of wireless transceivers and each wireless transceiver is operable by a different user who is a potential first responder.

8. The system of claim 1, wherein the centralized computer server is programmed to instruct the wireless transceiver to search for and detect all wi-fi receivers and transmitters, Bluetooth devices, and associated Generic Attribute (GATT) profiles in proximity to an activated low energy communication protocol transmitter.

9. The system of claim 1, wherein the centralized computer server is programmed to detect multiple UUIDs received by a single receiver from the same location and treat them as a single emergency.

10. The system of claim 1, wherein the centralized computer server is programmed to locate good Samaritans who are in the nearby vicinity to the low energy communication protocol transmitter.

11. The system of claim 1, wherein the data packet includes information of the user's medical conditions and allergies.

12. The system of claim 1, wherein the data packet includes updated location information every time the periodic data packet is sent so as to enable first responders to track the alert device over time.

13. The system of claim 1, wherein the centralized computer server transmits information to all emergency contacts of the transmitter user and to all good Samaritan responders in the area of the user and the user in turn is informed via the transmitter that help has been summoned.

14. A method for alerting a desired recipient of an emergency situation, comprising:
a) distributing a wireless low energy communication protocol transmitter with a unique serial number to a user;
b) recording the low energy communication protocol transmitter serial number and correlating the serial number with the user's personal identification information and emergency contact information in a tracking program in a centralized computer server;
c) distributing a good Samaritan responder app to wireless transceivers of participating good Samaritan responders;
d) connecting the wireless transceivers of the participating good Samaritan responders to the tracking program of the centralized computer server upon electronic registration of the responder app in order to establish a network between the wireless transceivers of the participating good Samaritan responders and the centralized computer server;
e) monitoring the network via software instructions on the centralized computer server for transmissions from the wireless transceivers indicating receipt of a transmission from the low energy communication protocol transmitter;
f) uploading data from the transmission from the low energy communication protocol transmitter to the centralized computer server via a wireless transceiver in the network;
g) analyzing the data from the transmission from the low energy communication protocol transmitter and the wireless transceiver via the centralized computer server to determine the identity of the user of the low energy communication protocol transmitter, the location of the emergency transmitter when the transmission was made, the responder contact information for the user, the user of the wireless transceiver, and the location of the wireless transceiver; and
h) notifying responders via communication transmission from the centralized computer server.

15. The method of claim 14, further comprising:
a) querying wireless transceivers in the network via the tracking program in the centralized computer server to determine the proximity of other registered wireless transceivers with respect to the low energy communication protocol transmitter;
b) identifying in the centralized computer server from among the wireless transceivers found in proximity of the low energy communication protocol transmitter any wireless transceivers that are designated as good Samaritan responders;
c) alerting, via communication from the centralized computer server, responders from the low energy transmitters contact list, the identified nearby good Samaritan responders, and governmental emergency services that the low energy transmitter has been activated;
d) querying wireless transceivers in the area of the low energy transmission to determine if more recent transmissions from the low energy communication protocol transmitter have been received;
e) updating all notified responders via the centralized computer server of any newly received low energy transmissions; and
f) monitoring and recording by the centralized computer server all wireless transceivers in the area of the low energy communication protocol transmission for additional information regarding the low energy communication protocol transmitter status until the activated status has been deactivated.

16. The system of claim 14, wherein the low-energy communication protocol transmitter includes a Bluetooth Low Energy (BTLE) beacon.

17. The system of claim 14, wherein the wireless transceiver includes a cellular transceiver.

18. A method for remotely alerting a desired recipient of an emergency using a portable personal emergency alert system, comprising:
a) activating a low energy communication protocol transmitter to periodically transmit a data package including a UUID;
b) authorizing a wireless transceiver to receive the BTLE data packet transmission and to transmit the data packet via a cellular transmission; and
c) authorizing a centralized computer server in a data center to receive the cellular transmission, process the data packet to determine a desired recipient and transmit an alert to the desired recipient.

19. The system of claim 18, wherein the low-energy communication protocol transmitter includes a Bluetooth Low Energy (BTLE) beacon.

20. The system of claim 18, wherein the wireless transceiver includes a cellular transceiver in the form of a cellular telephone.
